(19) United States
(12) Patent Application Publication
(10) Pub. No.: US 2005/0275849 A1
(43) Pub. Date: Dec. 15, 2005

(54) Method of calibrating an interferometer and method of manufacturing an optical element

(75) Inventors: Rolf Freimann, Aalen (DE); Bernd Doerband, Aalen (DE); Frank Schillke, Aalen (DE); Susanne Beder, Aalen (DE); Stefan Schulte, Aalen-Waldhausen (DE)

Correspondence Address: JONES DAY, 2882 SAND HILL ROAD, SUITE 240, MENLO PARK, CA, 94025, US

(73) Assignee: Carl Zeiss SMT AG, Oberkochen (DE)

(21) Appl. No.: 11/133,329

(22) Filed: May 20, 2005

Related U.S. Application Data
(63) Continuation-in-part of application No. PCT/EP02/13091, filed on Nov. 21, 2002.

(51) Int. Cl. G01B 9/02

(52) U.S. Cl. 356/521

(57) ABSTRACT

A method of calibrating an interferometer for determining an optical property of the interferometer uses a calibrating optical arrangement. The calibrating optical arrangement comprises at least one diffractive pattern and a mirror having a reflecting surface. The diffractive pattern and the reflecting surface are disposed at a distance from each other in a beam path of measuring light emitted from an interferometer optics of the interferometer system to be calibrated.

This application is a continuation-in-part of International Application No. PCT/EP2002/013091 filed on Nov. 21, 2002, which International Application was not published by the International Bureau in English on Jun. 3, 2004, the entire contents of which are incorporated herein by reference.

### BACKGROUND OF THE INVENTION

1. Field of the Invention

The present invention relates to the technical field of manufacturing optical elements and testing of optical elements using an interferometer. In particular, the present invention relates to a method of interferometric methods of objects having an aspherical surface.

2. Brief Description of Related Art

The optical element is, for example, an optical lens or an optical mirror used in an optical system, such as a telescope used in astronomy and a projection optical system used for imaging structures, such as structures formed on a mask or reticle, onto a radiation sensitive substrate, such as a resist, in a lithographic method. The success of such an optical system is substantially determined by the accuracy with which the optical surface can be processed or manufactured to have a target shape determined by a designer of the optical system. In such manufacture it is necessary to compare the shape of the processed optical surface with its target shape, and to determine differences between the processed and target surfaces. The optical surface may then be further processed at those portions where differences between the machined and target surfaces exceed e.g. predefined thresholds.

Interferometric apparatuses are commonly used for high precision measurements of optical surfaces. Examples of such apparatus are disclosed in U.S. Pat. Nos. 4,732,483, 4,340,306, 5,473,434, 5,777,741, 5,488,477. The entire contents of these documents are incorporated herein by reference.

U.S. Pat. No. 5,737,079 discloses a method for testing an aspherical surface. The aspherical surface is disposed in a beam path of measuring light of an interferometer The interferometer comprises a compensation system that shapes beam of measuring light emitted by a light source such that the measuring light is substantially orthogonally incident on the optical surface at each location thereof. Thus, wavefronts of the measuring light have substantially a same shape as the surface shape of the optical surface on which the measuring light is orthogonally incident. Compensation systems are also referred to as null-lenses, null-lens system, K-systems and null-correctors. Background information relating to such compensating systems is available e.g. from Chapter 12 of the text book of Daniel Malacara “Optical Shop Testing”, 2^{nd} Edition, John Wiley & Sons, Inc. 1992.

The measuring light reflected from the tested optical surface is superimposed with reference light, in order to generate an interference pattern from which deviations of the surface shape of the optical element from a target shape thereof may be determined.

Herein, an accuracy with which the deviations of the surface shape from its target shape can be determined is limited by an accuracy with which the compensating system conforms with a specification thereof.

The article by Jim Burge, “Certification of null correctors for primary mirrors”, Advanced Optical Manufacturing and Testing IV, Proc. SPIE 1994, pages 248 to 259, describes a method by which optical properties of a compensation system of an interferometer can be determined. For this purpose, a rotationally symmetric computer generated hologram (CGH) is disposed in the beam path of measuring light of the interferometer. The hologram is a diffraction patter, that was computed and manufactured in advance such that effect of the hologram on the measuring light is substantially equal to an effect of the optical surface having exactly the target shape arranged in the measuring light. Optical properties of the compensating system can be determined from interference patterns recorded with measuring light reflected from the hologram. These optical properties can then be used as calibrating information of the interferometer and can be taken into account when the optical surface to be manufactured is tested with the interferometer.

It has been found that the conventional methods of calibrating an interferometer using a diffractive pattern have an insufficient accuracy in some applications.

### SUMMARY OF THE INVENTION

The present invention has been accomplished taking the above problems into consideration.

Embodiments of the present invention provide a method of calibrating an interferometer using a diffractive pattern, and a method of manufacturing an optical element having using an interferometer.

Further, embodiments of the present invention provide a method of testing and manufacturing an optical element having an aspherical surface of a relatively high accuracy.

According to an embodiment of the invention, a calibrating optical arrangement rather than the optical surface to be tested is disposed in the beam path of the an interferometer. The effect of the calibrating optical arrangement on the incident measuring light and wavefronts is essentially equal to an effect of an optical element having the target shape arranged in the measuring light.

The calibrating optical arrangement comprises a mirror having a predetermined reflecting surface and a predetermined diffractive pattern which is separate from the reflecting surface. The reflecting surface may have a shape that can be manufactured with high accuracy. Examples of such surface shapes are a flat shape and a spherical shape.

The diffractive pattern is computed and produced such that the measuring light emitted from the interferometer optics is deflected by diffraction at the pattern such that the measuring light is substantially orthogonally incident on the reflecting surface.

It may be noted that the diffractive pattern used in the conventional calibrating optics illustrated in the above mentioned article by Jim Burge has function of reflecting the measuring light. In contrast thereto, in the illustrated embodiment, the measuring light is reflected by the mirror surface of the calibrating optics, and the diffractive pattern is separate from the mirror.

Thus, the diffractive pattern of the calibrating optics of the embodiment may have a line density which is less than a line density of a diffractive pattern of a corresponding calibrating optics manufactured according to the prior art.

A diffractive pattern having a lower line density may be easier to manufacture with a high accuracy than a diffractive pattern having a higher line density. Further, the effect of the diffractive pattern having the lower line density on the measuring light may be predicted with a higher precision than the effect of a diffractive pattern having a higher line density. For determining the effect of the diffractive pattern having the lower line density, calculations based on a scalar diffraction theory may be sufficient, whereas calculations based on rigorous diffraction theories may be necessary for determining the effect of the diffractive pattern having the higher line density.

According to an exemplary embodiment of the invention, it is possible to calibrate an interferometer optics including a compensating system of an interferometer, such as a rotationally symmetric refractive compensation system, for testing aspherical surfaces. The calibrated interferometer optics may than be used for testing aspherical optical surfaces to a high accuracy.

According to an exemplary embodiment of the invention, a method for calibrating an interferometer comprises: disposing a calibrating optical arrangement in a beam of measuring light emitted from an interferometer optics of an interferometer, the calibrating optical arrangement comprising at least one predetermined diffractive pattern and a mirror having a reflecting surface of a predetermined shape, and wherein the calibrating optical arrangement is disposed in the beam of measuring light such that the measuring light emitted from the interferometer optics traverses the diffraction pattern, is then reflected from the reflecting surface of the mirror, traverses the diffractive pattern again, propagates back to the interferometer optics, and traverses the interferometer optics; superimposing the measuring light having traversed the interferometer optics with reference light to generate an interference pattern; and determining at least one optical property of the interferometer based upon the interference pattern.

According to an exemplary embodiment of the invention, a method of manufacturing an optical element comprises: disposing a calibrating optical arrangement in a beam of measuring light emitted from an interferometer optics of an interferometer, the calibrating optical arrangement comprising at least one predetermined diffractive pattern and a mirror having a reflecting surface of a predetermined shape, and wherein the calibrating optical arrangement is disposed in the beam of measuring light such that the measuring light emitted from the interferometer optics traverses the at least one diffraction pattern, is then reflected from the reflecting surface of the mirror, traverses the at least one diffractive pattern again, propagates back to the interferometer optics, and traverses the interferometer optics; superimposing the measuring light reflected from the mirror surface of the calibrating optical arrangement and having traversed the interferometer optics with reference light to generate a first interference pattern, and recording the first interference pattern; and disposing the optical element in the beam of measuring light such that the measuring light emitted from the interferometer optics is reflected from a surface of the optical element, propagates back to the interferometer optics, and traverses the interferometer optics; superimposing the measuring light reflected from the surface of the optical element and having traversed the interferometer optics with the reference light to generate a second interference pattern, and recording the second interference pattern; and processing the optical surface of the optical element based upon the first interference pattern and the second interference pattern.

According to an exemplary embodiment herein, the interferometer optics is configured such and the optical element is disposed in the beam of measuring light such that the beam of measuring light is substantially orthogonally incident on the optical surface of the optical element at each location thereof.

According to a further exemplary embodiment herein, the machining of the optical surface of the optical element comprises at least one of milling, grinding, loose abrasive grinding, polishing, ion beam figuring, magneto-rheological figuring, and finishing of the optical surface of the optical element. The finishing may comprise applying a coating to the optical surface, and the coating may comprise at least one of a reflective coating, an anti-reflective coating and a protective coating.

### BRIEF DESCRIPTION OF THE DRAWINGS

The forgoing as well as other advantageous features of the invention will be more apparent from the following detailed description of exemplary embodiments of the invention with reference to the accompanying drawings. It is noted that not all possible embodiments of the present invention necessarily exhibit each and every, or any, of the advantages identified herein.

FIG. 1 shows an interferometer system having an optical element to be manufactured with high precision arranged in a beam of measuring light;

FIG. 2 shows an embodiment of a calibrating optical arrangement disposed in the beam of measuring light of the interferometer system shown in FIG. 1;

FIG. 3 shows a further embodiment of a calibrating optical arrangement disposed in the beam of measuring light of the interferometer system shown in FIG. 1;

FIG. 4 shows a further variant of calibrating optical arrangement;

FIG. 5 illustrates a distribution of line densities of a diffractive pattern of the calibrating optical arrangement shown in FIG. 4;

FIG. 6 shows a still further variant of calibrating optical arrangement;

FIG. 7 illustrates a distribution of line densities of a diffractive pattern of the calibrating optical arrangement shown in FIG. 6;

FIG. 8 shows a still further variant of calibrating optical arrangement;

FIG. 9 illustrates a distribution of line densities of a diffractive pattern of the calibrating optical arrangement shown in FIG. 8;

FIG. 10 shows a still further variant of calibrating optical arrangement;

FIG. 11 illustrates a distribution of line densities of a diffractive pattern of the calibrating optical arrangement shown in FIG. 10;

FIG. 12 shows a still further variant of calibrating optical arrangement;

FIG. 13 shows a further example of an interferometer system for testing an optical surface; and

FIG. 14 shows a flow chart of a method of manufacturing an optical element.

### DETAILED DESCRIPTION OF EXEMPLARY EMBODIMENTS

In the exemplary embodiments described below, components that are alike in function and structure are designated as far as possible by alike reference numerals. Therefore, to understand the features of the individual components of a specific embodiment, the descriptions of other embodiments and of the summary of the invention should be referred to.

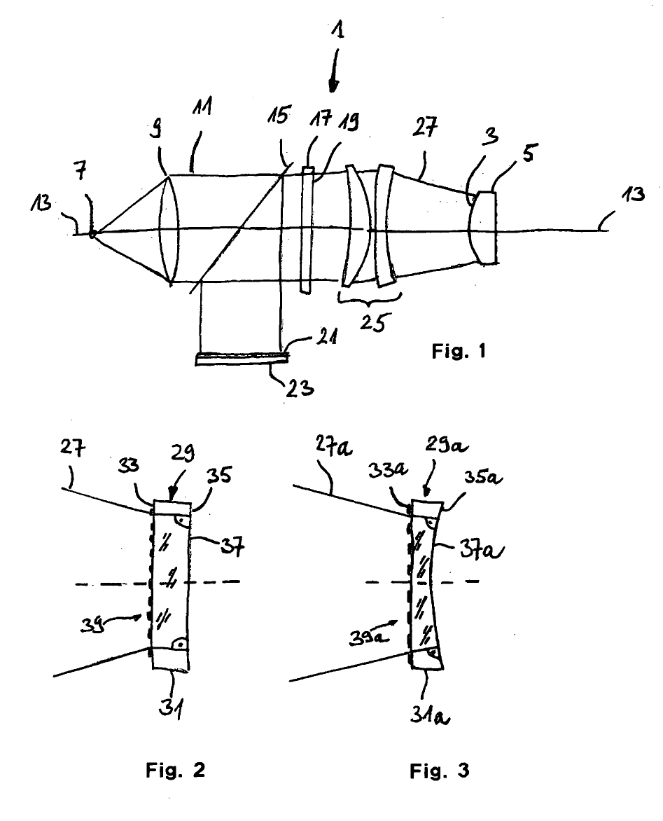

An interferometer system 1 schematically illustrated in FIG. 1 is used for testing an optical surface 3 of an optical component 5. The optical surface of the illustrated example has an aspherical surface shape. The Interferometer 1 of the illustrated example is of a Fizeau type and comprises a light source 7 emitting measuring light, The emitted light is formed to a parallel beam 11 by a collimation optics 9 such that wavefronts of the light of beam 11 are substantially flat wavefronts oriented orthogonal to an optical axis 13 of the interferometer 1. The wavefronts traverse a beam splitter 15 and a plate 17 having a surface 19 which provides a semi transparent flat reference surface which is the Fizeau surface of the interferometer. Measuring light reflected back from the reference surface 19 travels back in the interferometer in a direction opposite to the direction of the beam 11 of measuring light, and is reflected from the semi transparent mirror surface of beam splitter 15 and is incident on a radiation sensitive surface 21 of a position sensitive CCD detector 23.

A portion of the beam 11, which is not reflected from the reference surface 19, traverses a compensation system 25 which transforms the beam having the flat wavefronts into converging beam 27 having aspherical wave-fronts. The beam 27 of measuring light is substantially orthogonally incident onto the optical surface to be tested at each location thereof. The optical surface 3 and the aspherical wave-fronts incident thereon have substantially the same shapes. The compensation system for shaping the beam 27 and wavefronts thereof as illustrated above is also referred to as a null-lens or a null corrector in the art.

The beam 27 of measuring light is reflected from the surface 3 so that the beam 27 travels back to the compensation system 25 and is converted by the compensation system 25 into a parallel beam having substantially flat wave-fronts in a situation where the surface 3 of the mirror 5 corresponds to its ideal target surface. As far as these wave-fronts are reflected from the mirror 15, they are incident on the surface 21 of the detector 23, superimposed with the wavefronts reflected from the reference surface 19 to form an interference pattern on the radiation sensitive surface 21 of the detector 23. If the optical surface 3 of the mirror 5 deviates from its target shape, the wavefronts of the measuring light reflected from the optical surface 3 incident on the detector will show a corresponding deviation from the flat shape, resulting in a characteristic modification of the interference pattern generated on and recorded by the detector 23.

Deviations of the surface shape of surface 3 of the mirror from its target surface can be determined by analyzing the interference patterns recorded by the detector 23.

The determination of the deviations is however limited due to errors generated by the compensation system when shaping the beam 27 of measuring light having the aspherical wavefronts. As a consequence, it is desirable to calibrate the interferometer optics including the compensation system 25.

For calibrating the interferometer 1, a calibrating optical arrangement 29 is disposed in the beam path of beam 27 of measuring light of the interferometer 1 in place of the object 5, as is schematically illustrated in FIG. 2.

The calibrating optical arrangement 29 comprises a glass plate 31 having two plane-parallel surfaces at a front-side 33 and a back-side 35, respectively. The back-side 35 provides a reflecting surface 37, and the front-side 33 carries a diffractive pattern 39. Diffracting elements, such as lines, of the diffractive pattern 39 are selected such that they convert the aspherical wave-fronts of the beam 27 into parallel wave-fronts such that the beam 27 is orthogonally incident on the reflecting surface 37 of the calibrating optical arrangement 29. The incident beam is reflected on itself from the reflecting surface 37 and traverses the diffractive pattern 39 again, wherein the beam is again diffracted by the diffractive pattern 39 and travels back towards the compensation system. The diffractive pattern 39 and the reflecting surface 37 are designed such that the calibrating optical arrangement 29 has substantially the same effect on the beam 27 as it would be caused in a situation where the aspherical optical surface having the target shape is disposed in the beam of measuring light.

By using the interference patterns generated with the calibrating optical arrangement disposed in the beam path, it is possible to determine calibrating data which can be used for correcting measurement results obtained by interferometric measurements performed with the interferometer 1. In particular, a reference wavefront may be determined from the interference patterns generated with the calibrating optical arrangement disposed in the beam path, and the reference wavefront can be subtracted from future measurements of actual optical surfaces 3 of mirrors 5.

FIG. 3 shows a further example of a calibrating optical arrangement which may be used for calibrating the interferometer 1 shown in FIG. 1. The calibrating optical arrangement 29a shown in FIG. 3 comprises a glass substrate 31a having a flat front surface 33a carrying a diffractive pattern 39a, and a back surface 35a having a spherical shape forming the mirror surface of the calibrating optical arrangement 29a. When the calibrating optical arrangement 29a is disposed in the beam 27 of measuring light of the interferometer 1 shown in FIG. 1, the beam 27 incident on the diffractive pattern 39a diffracts the measuring light such that it is orthogonally incident on the reflecting surface 37a at each location thereof.

The calibrating optical arrangement 29a of FIG. 3 has an advantage that the substrate 31a may be tested and manufactured with a high accuracy, since its front and back surfaces have different curvatures. The calibrating optical arrangement 29 of FIG. 2 may have a disadvantage in that an interferometric test of the front surface is affected by measuring light reflected from the back surface, and an interferometric test of the back surface may be affected by measuring light reflected from the front surface.

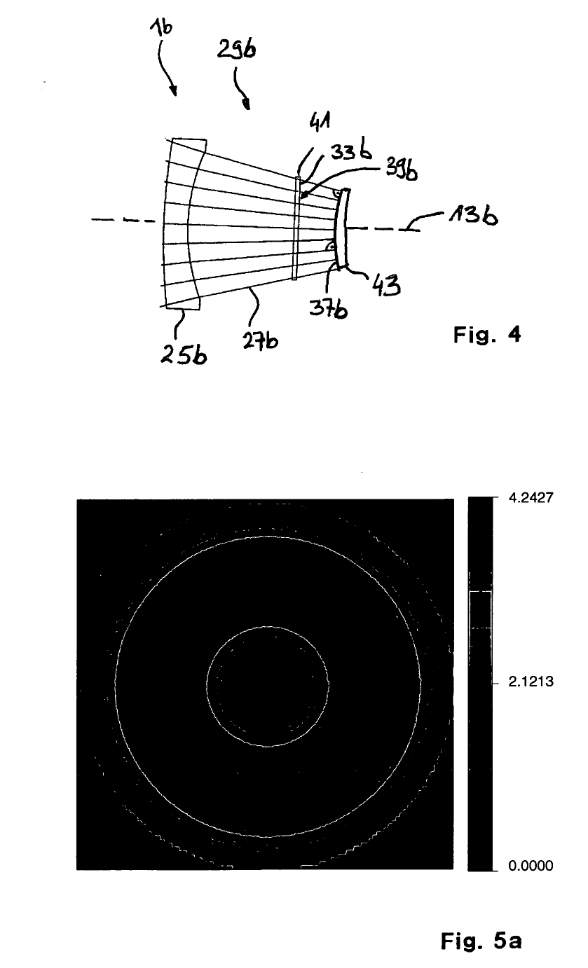

FIG. 4 schematically illustrates a portion of an interferometer 1b having an interferometer optics including a compensating lens 25b, wherein a calibrating optical arrangement 29b is disposed in a beam 27b of measuring light.

The calibrating optical arrangement 29b comprises a first transparent substrate 41 carrying a diffractive pattern 39b on a side 33b thereof, and a second substrate 43 providing a spherical reflecting surface 37b. In this example, the diffractive pattern 39b and the mirror surface are provided on different substrates 41, 43 rather than on a common substrate as illustrated with reference to the examples shown in FIGS. 2 and 3.

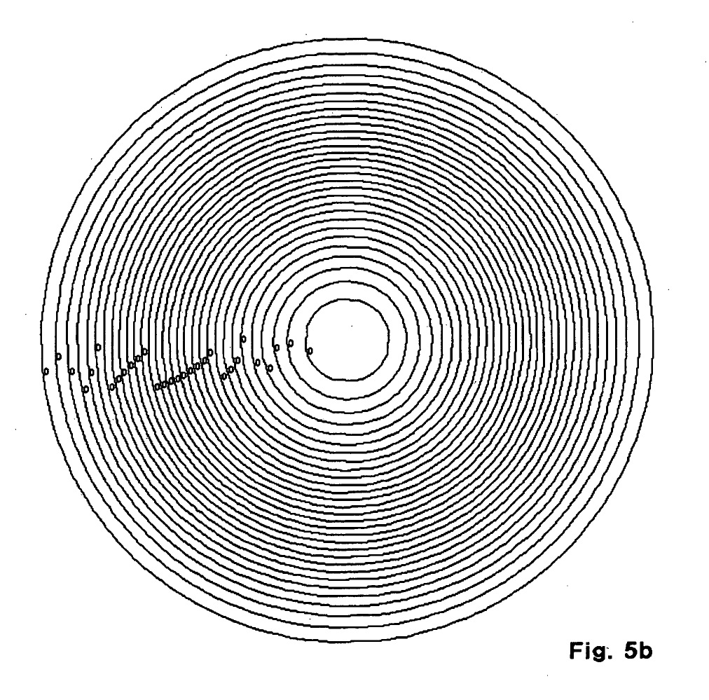

FIG. 5a is a grey colour representation and FIG. 5b is a contour line representation of a distribution of line densities of the diffractive pattern 39b. From these figures it is apparent that the pattern is concentric to an optical axis 13b of the compensation lens 25b.

In the example of the representation of the line densities according to FIG. 5b, one contour line represents seven lines of the diffractive pattern 39b. Thus, a line density at a given location of the diffractive pattern 39b is equal to a line density at a corresponding location in FIG. 5 multiplied by seven. A diameter of the diffractive pattern 39b shown in FIGS. 4 and 5 is 239.476 mm.

The two substrates 41 and 43 are fixed to a common mounting structure, not shown in FIG. 4. However, since both the spherical mirror 37b and the lines of the diffractive pattern 39b are concentric to the optical axis 13b, an adjustment of the substrates 41 and 43 relative to each other requires some effort.

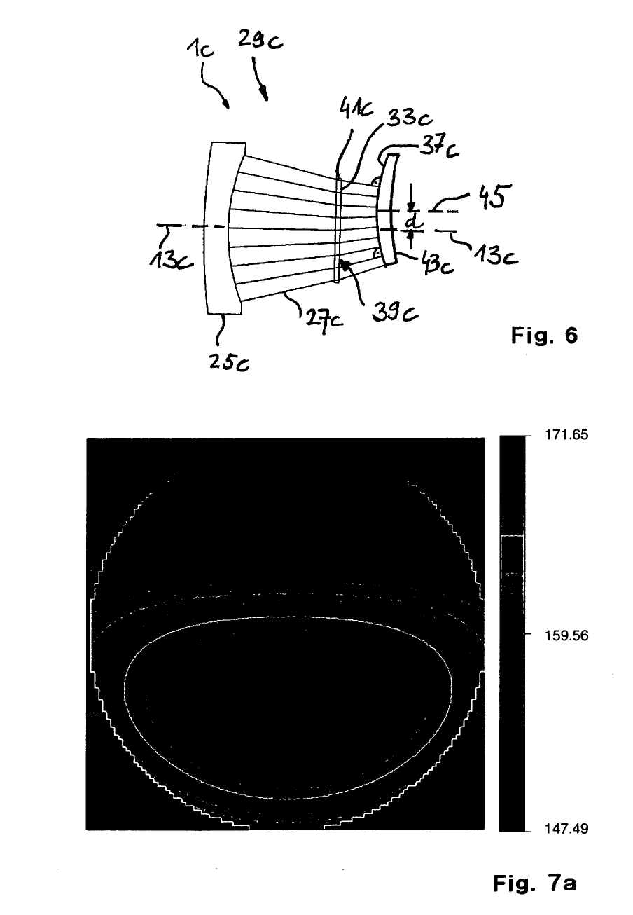

FIG. 6 schematically illustrates a portion of an interferometer 1c having an interferometer optics including a compensating lens 25c, wherein a calibrating optical arrangement 29c is disposed in a beam 27c of measuring light.

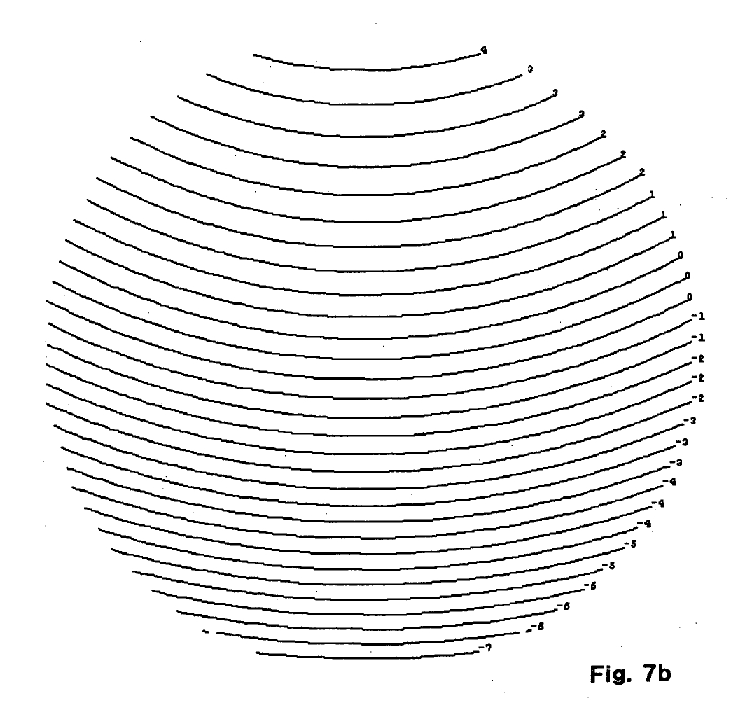

The calibrating optical arrangement 29c comprises a first transparent substrate 41c carrying a diffractive pattern 39c on a side 33c thereof, and a second substrate 43c providing a spherical reflecting surface 37c. An axis 45 of symmetry of the reflecting surface 37c is disposed at a distance d from an optical axis 13c of symmetry of the compensating lens 25c. In order to diffract the light of the beam 27c such that it is orthogonally incident on the mirror surface 27c, the diffractive pattern 33c has a non-rotationally symmetric configuration. In particular, the diffractive pattern is generated from a rotationally symmetric phase function applied to a linear carrier, such that the resulting pattern 33c is formed asymmetrically with respect to the axis 13c as it is apparent from a line density distribution shown in FIGS. 7a as a grey colour representation and in FIG. 7b as a contour line representation.

The two substrates 41c and 43c are fixed to a common mounting structure, not shown in FIG. 6. Since the spherical mirror 37c and the structure of the diffractive pattern 39c are not concentric to a common axis of symmetry, an adjustment of the substrates 41c and 43c relative to each other is simplified as compared to the example illustrated with reference to FIGS. 4 and 5.

In the example of the representation of the line densities according to FIG. 7b, one contour line represents 585 lines of the diffractive pattern 39c. Thus, a line density at a given location of the diffractive pattern 39c is equal to a line density at a corresponding location in FIG. 7b multiplied by 585. A diameter of the diffractive pattern 39c shown in FIGS. 6 and 7 is 239.476 mm.

Background information with respect to computer-generated holograms (CGHs) and other applications thereof in interferometry can be found, for example, chapter 15.3 of the textbook of Daniel Malacara cited above.

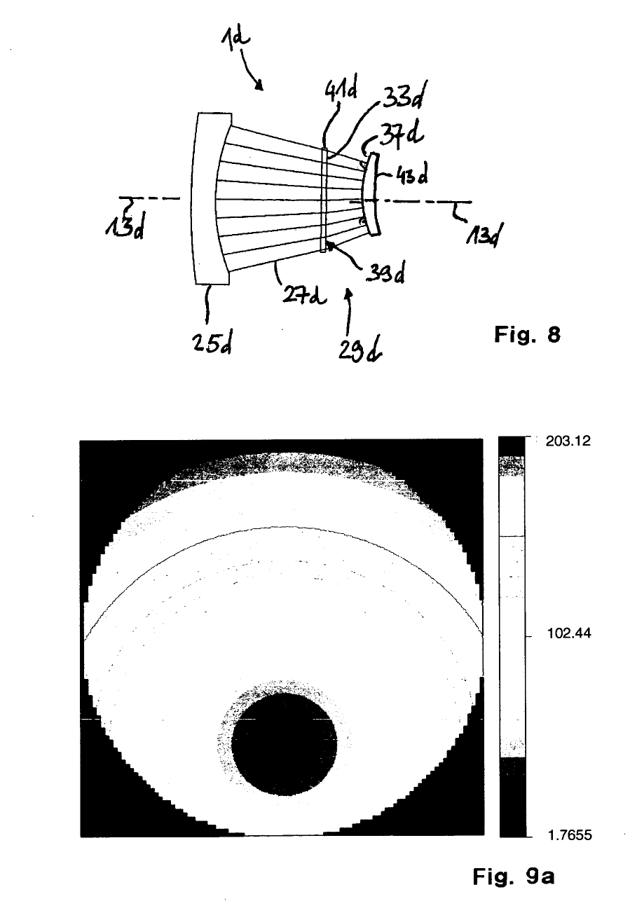

FIG. 8 schematically illustrates a portion of an interferometer 1d. having an interferometer optics including a compensating lens 25d, wherein a calibrating optical arrangement 29d is disposed in a beam 27d of measuring light. Similar to the example illustrated with reference to FIG. 4, a spherical mirror 37d is concentric with respect to an optical axis 13d of the compensating lens 25d. However, the spherical mirror 37d and a diffractive pattern 39d are not concentric to a common axis of symmetry.

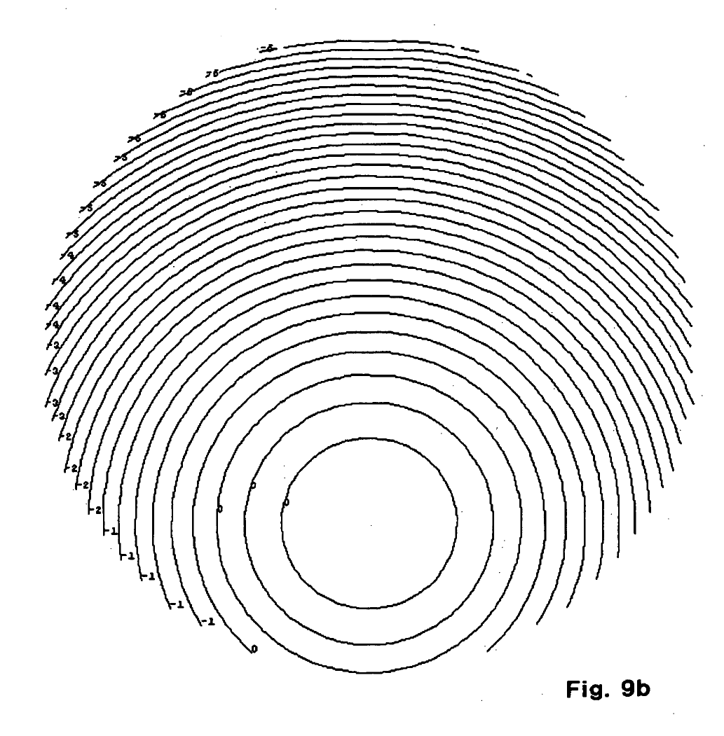

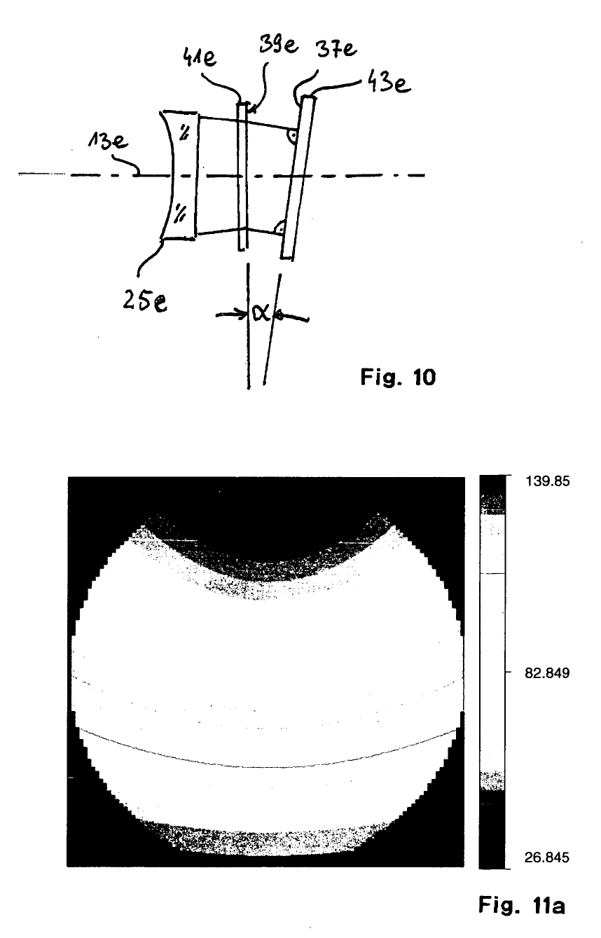

The diffractive pattern 39d is generated using a quadratic carrier, such that the resulting diffractive pattern 33d is formed asymmetrically with respect to an axis 13d as it is apparent from a line density distribution shown in FIGS. 9a as a grey colour representation and in FIG. 9b as a contour line representation.

In the example of the representation of the line densities according to FIG. 9b, one contour line represents 386 lines of the diffractive pattern 39d. Thus, a line density at a given location of the diffractive pattern 39d is equal to a line density at a corresponding location in FIG. 9b multiplied by 386. A diameter of the diffractive pattern 39d shown in FIGS. 8 and 9 is 239.476 mm.

FIG. 10 shows a calibrating optical arrangement 29e comprising a flat mirror 37e provided on a substrate 43e, and a diffractive pattern 39e provided on a substrate 41e. The substrates 41e and 43e are oriented under an angle α relative to each other such that the diffractive pattern 39e is not rotationally symmetric relative to an optical axis 13e of a compensating lens 25e of an interferometer optics of an interferometer to be calibrated.

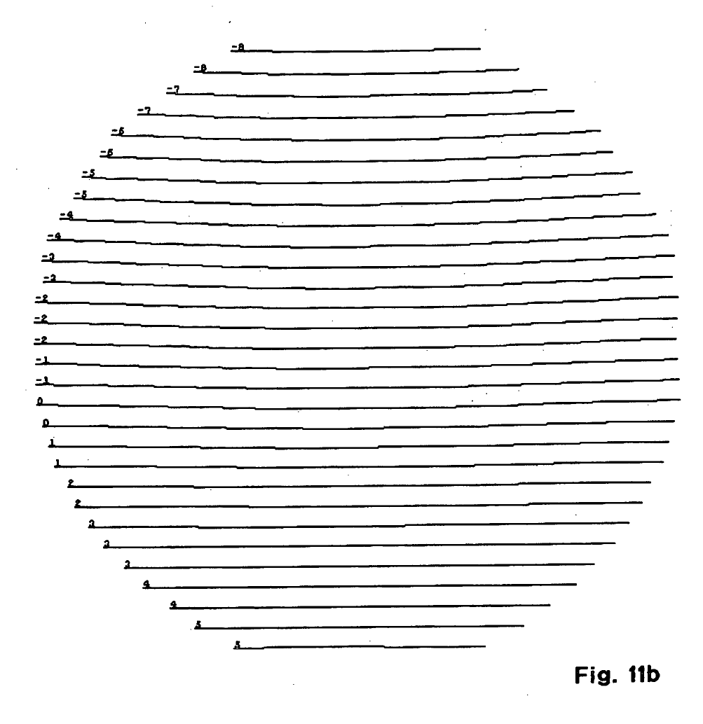

The diffractive pattern 39e is generated using a linear carrier. A line density distribution of the diffractive pattern 39e is shown in FIG. 11a as a grey colour representation and in FIG. 11b as a contour line representation.

In the example of the representation of the line densities according to FIG. 11b, one contour line represents 749 lines of the diffractive pattern 39e. Thus, a line density at a given location of the diffractive pattern 39e is equal to a line density at a corresponding location in FIG. 11b multiplied by 749. A diameter of the diffractive pattern 39e shown in FIGS. 10 and 11 is 239.476 mm.

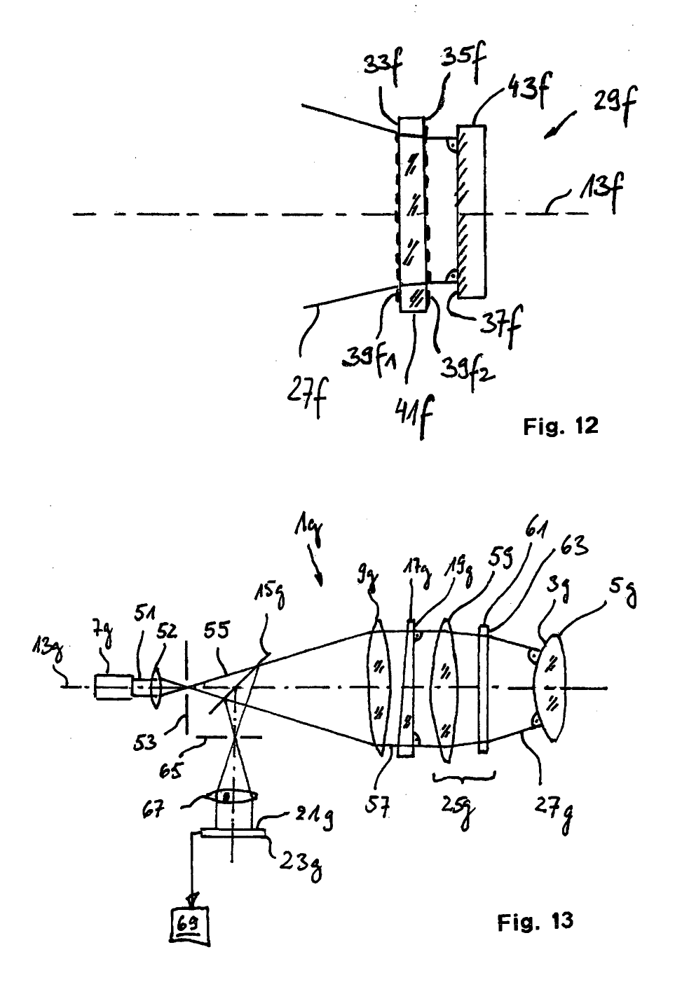

FIG. 12 shows a further embodiment of a calibrating optical arrangement 29f disposed in a beam 27f of measuring light emitted from an interferometer optics of an interferometer to be calibrated. The calibrating optical arrangement 29f comprises a first transparent substrate 41f and a second substrate 43f providing a flat reflecting surface 37f. The transparent substrate 41f has two plane-parallel surfaces 33f and 35f. Each of the two surfaces 33f and 35f carries a diffractive pattern 39f₁ and 39f₂, respectively, both of which are traversed by the beam 27f and diffract the beam such that it is orthogonally incident on the reflecting surface 27 at each location thereof.

The two diffractive patterns of the embodiment shown in FIG. 12 have the advantage that each of the two diffractive patterns may have a reduced line density as compared to the single diffraction pattern of the embodiments described with reference to FIGS. 4, 6, 8 and 10. The deflections caused by the respective diffractive patterns are added to a total deflection generated by the combined diffractive patterns 39f₁ and 39f₂.

FIG. 13 illustrates a further example of an interferometer system 1g suitable for testing an optical surface 3g of a lens 5g to be manufactured.

The interferometer system 1g comprises a light source 7g, such as a helium-neon-laser, for generating a light beam 51. Beam 51 is focused by a focusing lens arrangement 52, such as a micro-objective, onto a pinhole of a spatial filter 53 such that a diverging beam 55 of coherent light originates from the pinhole of the spatial filter 53. Wavefronts in the diverging beam 55 are substantially spherical wavefronts. The diverging beam 55 is collimated by a collimating lens arrangement 9g to form a substantially parallel beam 57 having substantially flat wavefronts. Parallel beam 57 traverses a wedge-shaped plate 17g having a flat surface 19g which is orthogonally disposed in the beam 57 to form a Fizeau surface of the interferometer apparatus 1g. The Fizeau surface 19g is semitransparent and reflects a portion of the intensity of the beam 57 to form a beam of reference light which travels back along optical axis 13g, is collimated by the collimating lens arrangement 9g to form a converging beam which is reflected from a beam splitter 15g disposed in diverging beam 55, and to be incident on a detection surface 21g of a camera 23g after having traversed a spatial filter 65 and a camera optics 67. The spatial filter 65 has a function of preventing undesired measuring light from being incident on the detection surface 21g of the detector 23g. Undesired measuring light may comprise measuring light reflected from surfaces other than the Fizeau surface 19g, the surface 3g to be manufactured or the reflecting surface of the calibrating optical arrangement. Further, the undesired measuring light may comprise light diffracted by the computer generated hologram 63 or the diffractive pattern of the calibrating optical arrangement into a diffraction order other than a desired diffraction order. The camera 23g may be of a CCD type having a plurality of photosensitive pixels for detecting an interference pattern which is output to a controller 69.

A portion of the light beam 57 traversing the Fizeau surface 19g is collimated by an interferometer optics 25g to form a converging beam 27g orthogonally incident on the surface 3g to be tested.

The interferometer optics 259 comprises a focussing lens 59 and a computer generated hologram 63 provided on a substrate 61. The lens 51 and the hologram 63 are configured such that the beam 27g of measuring light has, at a position of the surface 3g to be tested, wavefronts of a shape corresponding to the target shape of surface 3g.

Also the interferometer 1g having the interferometer optics 25g comprising a computer generated hologram, can be tested by using a calibrating optical arrangement as illustrated above with reference to FIGS. 2 to 12.

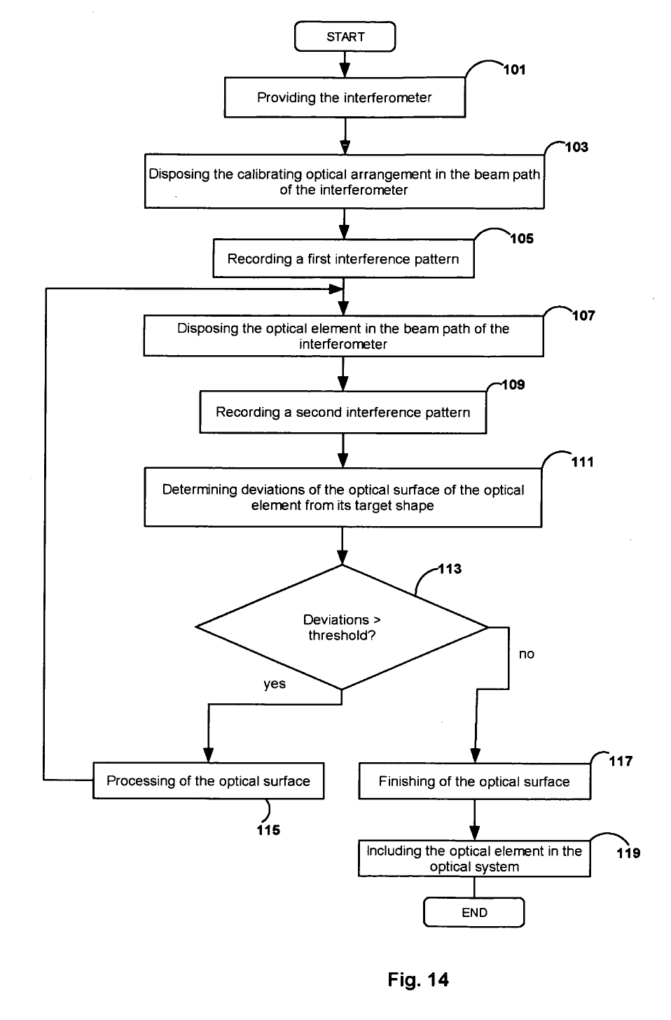

A method of manufacturing a mirror having an aspherical surface to a high accuracy using an interferometer system calibrated as illustrated above is illustrated with reference to the flowchart shown in FIG. 14.

An interferometer 1 according to FIG. 1 is provided in a step 101. A calibrating optical arrangement is disposed in a beam path of the interferometer in a step 103. The calibrating optical arrangement may have a structure as illustrated above with reference to FIGS. 2 to 12, or any other suitable structure. For this purpose, the calibrating optical arrangement is designed and manufactured such that an optical effect of the calibrating optical arrangement on the beam of measuring light corresponds to an optical effect of the aspherical surface having the target shape disposed in the beam of measuring light. The shape of the reflecting surface of the calibrating optical arrangement may be selected such that the reflecting surface can be manufactured with high accuracy. The configuration of the diffractive pattern of the calibrating optical arrangement can be calculated by using computer, and the diffractive pattern can be manufactured with high precision, such that the diffractive pattern together with the reflecting surface provides essentially the same optical characteristics as the aspherical mirror, if the aspherical mirror would have its target surface.

For example, the diffractive pattern (CGH) may be formed as a chrome mask provided on a glass substrate as an amplitude hologram. For example, the diffractive pattern (CGH) may also be provided as a phase hologram formed by a pattern of grooves provided in a surface of a glass substrate.

In a step 105, a first interference pattern is recorded by using the compensating optical component disposed in the beam path of the interferometer. Interferometer errors, and in particular rotational symmetric errors of the compensation system, can be determined with a high accuracy from an analysis of the recorded first interference pattern. These errors are subsequently taken into account when evaluating interference patterns that are recorded in measurements of optical surfaces to be manufactured.

For this purpose, the first interference pattern is evaluated by using a conventional method, and a map representing phase errors is generated. A map representing phase differences is typically generated from a second interference pattern recorded in a measurement of an optical surface to be manufactured. The map representing phase errors and the map representing phase differences can be entered in a computational method in order to determine surface defects of the surface to be manufactured. For example, it is possible to calculate a difference between values of the map representing the phase differences minus the values of the map representing the phase errors for each location of the maps. The resulting map represents, for each location of the surface to be manufactured, twice the deviation of the actual surface from its target shape.

The object to be manufactured is disposed in the beam path of the interferometer in a step 107. In a step 109, a second interference pattern of the mirror surface is recorded.

Deviations of the measured optical surface from its target shape are determined from the first and second recorded interference patterns in a step 111.

If the deviations of the mirror surface to be manufactured from its target surface exceed a predetermined threshold value in a decision step 113, the mirror surface is processed in a step 115 in order to reduce the deviations from the target shape. For this purpose, the optical element is removed from the beam path of the interferometer and mounted on a suitable machine tool to remove those surface portions of the optical surface at which differences between the determined surface shape and the target shape exceed the threshold. The processing may include operations such as milling, grinding, loose abrasive grinding, polishing, ion beam figuring and magneto-rheological figuring.

A result of the processing of the surface in step 115 is measured by re-arranging the object, i.e. the mirror with its reflector surface, in the beam path of the interferometer in step 107, and the procedure is repeatedly continued until the decision step 113 indicates that the deviations are less than or equal to the threshold value.

A subsequent finishing step 117 is then performed on the optical surface. The finishing may include a final polishing of the surface or depositing a suitable coating, such as a reflective coating, an anti-reflective coating, and a protective coating applied to the optical surface by suitable methods, such as sputtering. The reflective coating may comprise, for example, a plurality of layers, such as ten layers of alternating dielectric materials, such as molybdenum oxide and silicon oxide. Thicknesses of such layers may be about 5 nm and will be adapted to a wavelength to be reflected from the optical surface, such that a reflection coefficient is substantially high. Finally, the reflective coating may be covered by a protective cap layer for passivating the reflective coating. The cap layer may include a layer formed by depositing materials such as ruthenium. The anti-reflective coating which is intended to reduce reflections of radiation from the optical surface of the optical element, such as a lens element, may include materials, such as magnesium fluoride, lanthanum oxide and other suitable materials. Also the anti-reflective coating may be passivated by a protective cap layer.

After the optical surface is finished in step 117, the optical element is delivered and incorporated in an optical system in a step 119. Thereafter a next optical element to be manufactured is mounted in the interferometer beam path in step 107, and repeated measuring and machining of such next surface is performed until this surface fulfils the specifications.

The above threshold values will depend on the application of the optical surface in the optical system for which it is designed. For example, if the optical surface is a lens surface in an objective for imaging a reticle structure onto a resist with radiation of a wavelength λ=193 nm, such threshold value may be in a range of about 1 nm to 10 nm, and if the optical surface will be used as a mirror surface in an imaging objective using EUV (extreme ultraviolet) radiation with a wavelength of λ=13.5 nm, the threshold value will be in a region of about 0.1 nm to 1.0 nm. It is to be noted that it is not necessary that the above mentioned threshold is a constant threshold over the whole area of the optical surface. It is possible that the threshold is dependent on e.g. a distance from a center of the optical surface or some other parameters. In particular, plural thresholds may be defined each for different ranges of spatial frequencies of differences between the measured surface and its target shape.

In the above illustrated embodiments, the interferometer systems are of a Fizeau-type. It is to be noted, however, that the invention is not limited to such type of interferometer. Any other type of interferometer, such as a Twyman-Green-type of interferometer, examples of which are illustrated in chapter 2.1 of the text book edited by Daniel Malacara, Optical Shop Testing, 2nd edition, Wiley interscience Publication (1992), a Michelson-type interferometer, examples of which are illustrated in chapter 21 of the text book edited by Daniel Malacara, a Mach-Zehnder-type of interferometer, examples of which are illustrated in chapter 2.6 of the text book edited by Daniel Malacara, a point-diffraction type interferometer, examples of which are illustrated in U.S. Pat. No. 5,548,403 and in the article “Extreme-ultraviolet phase-shifting point-diffraction interferometer: a wavefront metrology tool with subangstrorn reference-wave accuracy” by Patrick P. Naulleau et al., Applied Optics-IP, Volume 38, Issue 35, pages 7252 to 7263, December 1999, and any other suitable type of interferometer may be used.

Furthermore, in the embodiments illustrated above, the surface to be manufactured is of a convex shape. However, it is also possible to apply the illustrated methods to a concave surfaces. Furthermore, it is also possible that the surface to be manufactured forms only a portion of a rotationally symmetric shape such that the optical element may be ref erred to as an off-axis element.

Furthermore, it is possible to replace the reflecting surface of the calibrating optical arrangement illustrated above by a diffractive element that is designed such that it simulates the reflecting surface, i.e. that it reflects back the incident beam of measuring light such that the reflected beam coincides with the incident beam.

The diffractive optical element can be formed as a blazed grating in order to increase a diffraction efficiency.

Summarized , embodiments of the present invention relate to a method of calibrating an interferometer for determining an optical property of the interferometer, wherein a calibrating optical arrangement is used. The calibrating optical arrangement comprises at least one diffractive pattern and a mirror having a reflecting surface. The diffractive pattern and the reflecting surface are disposed at a distance from each other in a beam path of measuring light emitted from an interferometer optics of the interferometer system to be calibrated.

The present invention has been described by way of exemplary embodiments to which it is not limited. Variations and modifications will occur to those skilled in the art without departing from the scope of the present invention as recited in the appended claims and equivalents thereof.

1. A method for calibrating an interferometer for testing an optical surface, the method comprising:
disposing a calibrating optical arrangement in a beam of measuring light emitted from an interferometer optics of an interferometer, the calibrating optical arrangement comprising at least one predetermined diffractive pattern and a mirror having a reflecting surface of a predetermined shape, and wherein the calibrating optical arrangement is disposed in the beam of measuring light such that the measuring light emitted from the interferometer optics traverses the diffraction pattern, is then reflected from the reflecting surface of the mirror, traverses the diffractive pattern again, propagates back to the interferometer optics, and traverses the interferometer optics;
superimposing the measuring light having traversed the interferometer optics with reference light to generate an interference pattern; and
determining at least one optical property of the interferometer based upon the interference pattern.

2. The method according to claim 1, wherein the reflecting surface of the mirror has a spherical shape.

3. The method according to claim 2, wherein the interferometer optics has an optical axis and wherein the calibrating optical arrangement is disposed in the beam of measuring light such that an axis of rotational symmetry of the reflecting surface of the mirror is arranged at a distance from the optical axis of the interferometer optics.

4. The method according to claim 1, wherein the reflecting surface of the mirror is a flat surface.

5. The method according to claim 1, wherein the calibrating optical arrangement comprises a transparent substrate having a front surface carrying the diffractive pattern and a back surface providing the reflecting surface.

6. The method according to claim 1, wherein the calibrating optical arrangement comprises a transparent first substrate carrying the diffractive pattern and a second substrate providing the reflecting surface.

7. The method according to claim 1, wherein the calibrating optical arrangement comprises plural diffraction patterns disposed at a distance from one another, wherein a first diffractive pattern of the plural diffraction patterns is disposed between the mirror surface of the mirror and a second diffractive pattern of the plural diffraction patterns.

8. The method according to claim 7, wherein the calibrating optical arrangement comprises a transparent substrate having a front surface carrying the second diffractive pattern and a back surface carrying the first diffraction pattern.

9. A method of manufacturing an optical element, the method comprising:
disposing a calibrating optical arrangement in a beam of measuring light emitted from an interferometer optics of an interferometer, the calibrating optical arrangement comprising at least one predetermined diffractive pattern and a mirror having a reflecting surface of a predetermined shape, and wherein the calibrating optical arrangement is disposed in the beam of measuring light such that the measuring light emitted from the interferometer optics traverses the at least one diffraction pattern, is then reflected from the reflecting surface of the mirror, traverses the at least one diffractive pattern again, propagates back to the interferometer optics, and traverses the interferometer optics;
superimposing the measuring light reflected from the mirror surface of the calibrating optical arrangement and having traversed the interferometer optics with reference light to generate a first interference pattern, and recording the first interference pattern; and
disposing the optical element in the beam of measuring light such that the measuring light emitted from the interferometer optics is reflected from a surface of the optical element, propagates back to the interferometer optics, and traverses the interferometer optics;
superimposing the measuring light reflected from the surface of the optical element and having traversed the interferometer optics with the reference light to generate a second interference pattern, and recording the second interference pattern; and
processing the optical surface of the optical element based upon the first interference pattern and the second interference pattern.

10. The method according to claim 9, wherein the interferometer optics is configured such and the optical element is disposed in the beam of measuring light such that the beam of measuring light is substantially orthogonally incident on the optical surface of the optical element at each location thereof.

11. The method according to claim 9, wherein plural optical elements, each having an optical surface, are subsequently disposed in the beam of measuring light, wherein a second interference pattern is recorded for each respective optical element, and wherein the optical surface of each optical element is processed based upon the first interference pattern and the second interference pattern associated with the respective optical element.

12. The method according to claim 9, wherein the reflecting surface of the mirror has a spherical shape.

13. The method according to claim 12, wherein the interferometer optics has an optical -axis and wherein the calibrating optical arrangement is disposed in the beam of measuring light such that an axis of rotational symmetry of the reflecting surface of the mirror is arranged at a distance from the optical axis of the interferometer optics.

14. The method according to claim 9, wherein the reflecting surface of the mirror is a flat surface.

15. The method according to claim 9, wherein the calibrating optical arrangement comprises a transparent substrate having a front surface carrying the diffractive pattern and a back surface providing the reflecting surface.

16. The method according to claim 9, wherein the calibrating optical arrangement comprises a transparent first substrate carrying the diffractive pattern and a second substrate providing the reflecting surface.

17. The method according to claim 9, wherein the calibrating optical arrangement comprises plural diffraction patterns disposed at a distance from one another, wherein a first diffractive pattern of the plural diffraction patterns is disposed between the mirror surface of the mirror and a second diffractive pattern of the plural diffraction patterns.

18. The method according to claim 17, wherein the calibrating optical arrangement comprises a transparent substrate having a front surface carrying the second diffractive pattern and a back surface carrying the first diffraction pattern.

19. The method according to claim 9, wherein the interferometer optics comprises a Fizeau surface from which the reference light is reflected and which is traversed by the beam of measuring light.

20. The method according to claim 9, wherein the optical surface has an aspherical shape.

21. The method according to claim 9, wherein the machining of the optical surface of the optical element comprises at least one of milling, grinding, loose abrasive grinding, polishing, ion beam figuring, magneto-rheological figuring, and finishing of the optical surface of the optical element.

22. The method according to claim 21, wherein the finishing comprises applying a coating to the optical surface.

23. The method according to claim 22, wherein the coating comprises at least one of a reflective coating, an anti-reflective coating and a protective coating.
